(19) United States
(12) Patent Application Publication
(10) Pub. No.: US 2009/0195921 A1
(43) Pub. Date: Aug. 6, 2009

(54) Method and apparatus for temperature control in a disk drive and/or an assembled circuit board

(75) Inventor: Dongman Kim, Campbell, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 12/012,928

(22) Filed: Feb. 5, 2008

(51) Int. Cl. G11B 33/14

(52) U.S. Cl. 360/97.02

(57) ABSTRACT

This application discloses and claims disk drives including a Phase Change Material (PCM) with a target temperature, where the PCM releases heat in response to an outside ambient temperature declining below the target, and the PCM absorbs heat in response to the ambient temperature rising above the target temperature. The disk drive may be a ferromagnetic disk drive, a ferroelectric disk drive, a hybrid disk drive, a Redundant Array of Inexpensive Disks (RAID), or a solid state disk drive. This patent application discloses a disk base and/or disk cover and/or any assembled circuit board containing PCM. Making the disk drive, the disk base, the disk cover and the assembled circuit board are disclosed and claimed as well.

### TECHNICAL FIELD

This invention relates to temperature control in disk drives and/or assembled circuit boards.

### BACKGROUND OF THE INVENTION

In the last few years, heat sinks and/or Peltier plates have been discussed as a way to at least partly control heat in a disk drive. However, these approaches cannot fundamentally prevent heat flow from outside environments, making such disk drives still sensitive to thermal cycling, necessitating temperature optimization and/or compensation to be implemented either in a controller and/or in a channel interface within the disk drive. These approaches also make the disk drive bulkier by adding more components, as well as adding design difficulties as well as increase the complexity of temperature related performance optimization. A mechanism is needed that is inexpensive, effective and simple by which heat transfer with the outside may be controlled.

### SUMMARY OF THE INVENTION

Embodiments of the invention include a disk drive including a Phase Change Material (PCM) with a target temperature, where the PCM releases heat in response to an ambient temperature outside the disk drive declining below the target temperature, and PCM absorbs heat in response to the ambient temperature rising above the target temperature. The disk drive may be a ferromagnetic disk drive, a ferroelectric disk drive, a hybrid disk drive, a Redundant Array of Inexpensive Disks (RAID), or a solid state disk drive. The PCM operates without electrical power or software supervision to compensate for changes in the ambient temperature away from the disk drive's optimal temperature range. The disk drive may include more than one PCM and different PCMs may have the same or differing target temperatures.

The disk drive may include a disk cover and/or a disk base including the PCM. The disk drive may also include an assembled circuit board including the PCM. Embodiments of the invention include the disk cover including the PCM, the disk base including the PCM and any assembled circuit board including the PCM. The disk base and disk cover operate similarly to the disk drive, and the assembled circuit board operates by releasing and absorbing heat associated with integrated circuits and/or connectors which would otherwise suffer from ambient temperature extremes.

Embodiments of the invention include manufacturing processes for the disk drive, the disk cover, the disk base and the assembled circuit board producing these products including at least one PCM.

### BRIEF DESCRIPTION OF THE DRAWINGS

FIGS. 1A to 1C shows an example embodiment of a disk drive 10 including at least one Phase Change Material (PCM) with a target temperature and operating with an ambient temperature in its outside environment. The disk drive may further include a disk base upon which may be mounted a disk cover and at least one assembled circuit board, where the disk base and/or the disk cover and/or the assembled circuit board may include at least one Phase Change Material (PCM). The target temperature may differ for a specific type of disk drive, such as a ferromagnetic disk drive, a ferroelectric disk drive, a hybrid hard disk drive, a Redundant Array of Inexpensive Disks (RAID), or a Solid State Drive. The disk drive operates with the outside ambient temperature by the PCM releasing heat in response to the ambient temperature declining below the target temperature as shown in FIG. 1B and the PCM absorbing heat in response to the ambient temperature rising above the target temperature as shown in FIG. 1C.

FIG. 2 shows a top view of the disk cover of FIG. 1, which may be covered with a PCM coating and/or filled with the PCM.

FIG. 3 shows a bottom view of the disk base and assembled circuit board of FIG. 1. The disk base may be covered with the PCM coating and/or filled with the PCM. The assembled circuit board may include integrated circuits and/or connectors also thermally coupled with the PCM.

FIG. 4 shows an encapsulated PCM containing multiple particles.

FIG. 5 shows a schematic of the particle of FIG. 4 including a component core with a heat of fusion near the target temperature and an outer inert shell.

FIG. 6 shows the disk cover including the encapsulated PCM of FIGS. 4 and 5 filling a gap between two metal plates.

FIG. 7 shows the disk cover including a PCM coating on a metal plate.

FIG. 8 shows the disk base including the PCM coating on a metal plate.

FIG. 9 shows part of the assembled circuit board of FIG. 1 and 3 including at least one of the integrated circuits and/or at least one of the connectors thermally coupled to their PCM coating.

And FIG. 10 shows at least one of the integrated circuits and/or at least one of the connectors thermally coupled to a PCM film between it and the circuit board.

### DETAILED DESCRIPTION

This invention relates to temperature control in disk drives. Embodiments of this invention include disk drives including a Phase Change Material (PCM) with a target temperature, where the PCM releases heat in response to an outside ambient temperature declining below the target, and the PCM absorbs heat in response to the ambient temperature rising above the target temperature. The disk drive may be a ferromagnetic disk drive, a ferroelectric disk drive, a hybrid disk drive, a Redundant Array of Inexpensive Disks (RAID), or a solid state disk drive. The disk drive may include a disk base and/or disk cover and/or an assembled circuit board containing PCM, which are also embodiments of this invention. Embodiments of the invention also include making the disk drive, the disk base, the disk cover and the assembled circuit board.

As used herein, a hybrid disk drive is a hard disk drive 10 that includes a large buffer of non-volatile semiconductor memory, for example, a flash-memory buffer, used to cache commonly used data during normal use. Because it is non-volatile, the cache retains its state, allowing very fast access to the most commonly used data and applications when the hard disk drive is restarted. In computer applications, by primarily using the large buffer, the disks are at rest more of the time decreasing power consumption and improving overall reliability. When the hard disk drive holds much of the boot code, the process of booting up the computer is made much faster when the boot code resides in the non-volatile buffer.

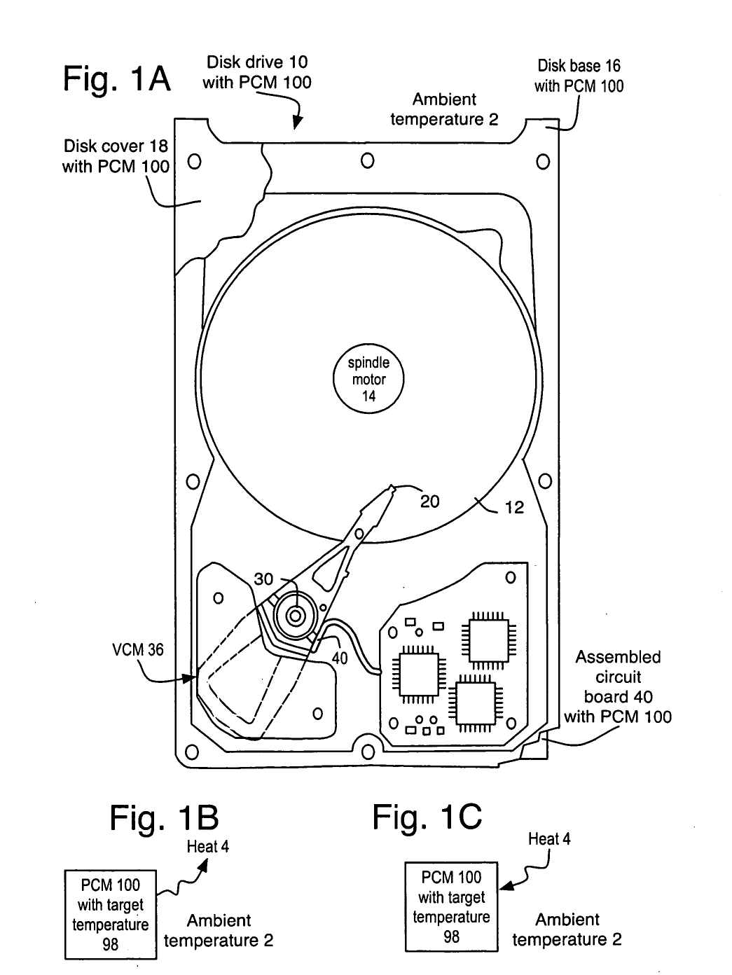

Referring to the drawings more particularly by reference numbers, FIGS. 1A to 1C shows an example embodiment of a disk drive 10 including at least one Phase Change Material (PCM) 100 with a target temperature 98 and operating with an ambient temperature 2 in its outside environment. The disk drive may further include a disk base 16 upon which may be mounted a disk cover 18 and an assembled circuit board 40, where the disk base and/or the disk cover and/or the assembled circuit board may include at least one Phase Change Material (PCM). The target temperature may differ for a specific type of disk drive, such as a ferromagnetic disk drive, a ferroelectric disk drive, a hybrid hard disk drive, a Redundant Array of Inexpensive Disks (RAID), or a Solid State Drive.

The disk drive 10 operates with the outside having an ambient temperature 2 by the PCM 100 releasing heat 4 in response to the ambient temperature declining below the target temperature 98 as shown in FIG. 1B and the PCM absorbing heat in response to the ambient temperature rising above the target temperature as shown in FIG. 1C. When present in the disk drive, the disk base 16 and/or the disk cover 18 with the PCM aid in controlling the thermal transport between the outside environment and disk components, for example, a spindle motor 14 for rotating at least one disk 12 and a voice coil motor 36 for positioning a slider 20, improving their performance and adding to the overall reliability of the disk drive.

As used herein, a PCM 100 may preferably include at least one component with a heat of fusion that is capable of storing and releasing large amounts of energy by melting and solidifying at or near the target temperature 98. When a PCM reaches the target temperature, it changes state to a liquid, having crossed the melting point and absorbing a large amount of heat without getting hotter. Also, the PCM responds to the ambient temperature of its surroundings dropping below the target temperature by returning to a solid state and releasing its stored latent heat. Typically such materials store five to fourteen times more heat per volume than conventional materials.

As used herein, a target temperature 98 will refer to the transition temperature of the PCM 100, at which it changes state either from liquid to solid or from solid to liquid. For example the target temperature may be close to 40° Centigrade (C.) as a normal ferromagnetic disk drive operating temperature.

When present in the disk drive 10, the spindle motor 14 may be mounted on the disk base 16 and coupled to at least one disk 12 to create at least one rotating disk surface as shown in FIG. 1A. A voice coil motor 36 may be mounted through an actuator pivot 30 to the disk base to move a slider 20 across the rotating disk surface.

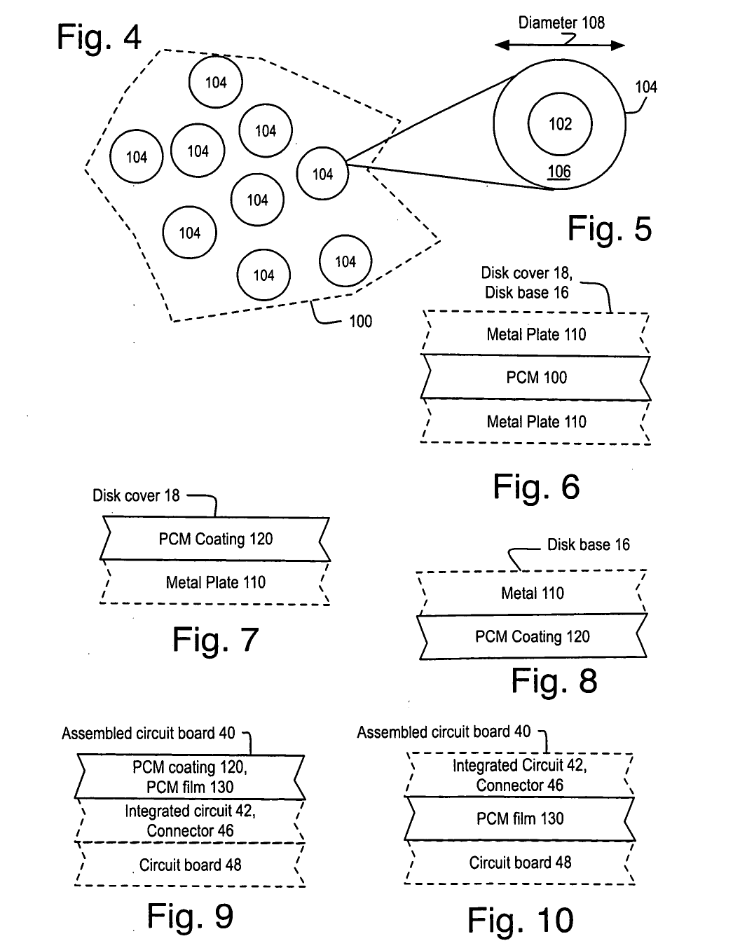

FIG. 2 shows an example embodiment of a disk cover 18 including the PCM 100. The disk cover may include particles 102 as will be discussed regarding FIGS. 4 and 5 and/or it may be coated with a PCM coating 120 as will be discussed in FIG. 7. In embodiments where the disk cover includes both particles and the PCM coating, the particles may have a different target temperature from the PCM coating. This may also occur in the disk drive 10, or the disk base 16.

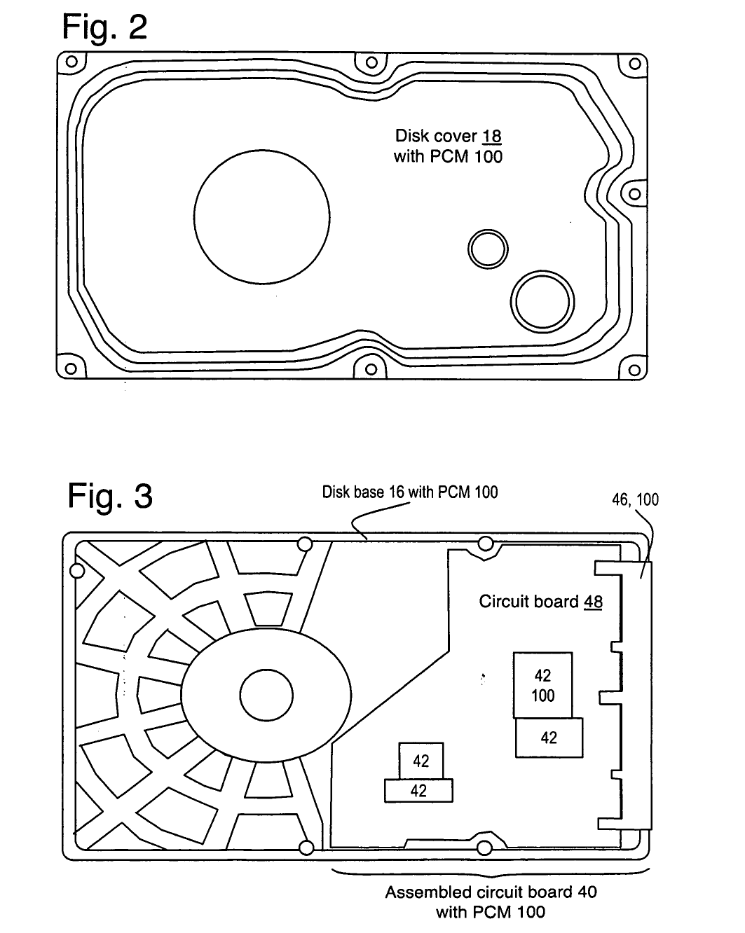

FIG. 3 shows an example embodiment of the disk base 16 and assembled circuit board 40 of FIG. 1A, where the disk base and/or the assembled circuit board may include PCM 100. The disk cover may include particles 102 as will be discussed regarding FIGS. 4 and 5 and/or it may be coated with a PCM coating 120 as will be discussed in FIG. 8. Note that FIG. 8 shows the PCM coating on the bottom side of the disk base, however the PCM coating may also be applied to any interior or exterior surface including sidewalls. The assembled circuit board may include at least one integrated circuit 40 with the PCM and/or at least one connector 46 with the PCM, which may in some embodiments of the invention be a PCM coating 120 as shown in FIG. 9 and/or a PCM film 130 as shown in FIGS. 9 and 10. By way of example the integrated circuit may be a System On a Chip (SOC) and/or an analog circuit such as a preamplifier and/or an Application Specific Integrated Circuit (ASIC) and/or a computer circuit and/or a memory integrated circuit. The connector may be a ribbon cable connector, a serial connector and/or a fiber optic connector.

One preferred PCM 100 may include particles 104 as shown in FIG. 4. The particle 104 is shown in FIG. 5 and may contain a core material 102 encapsulated in an outer inert shell 106. The core material may include a form of paraffin, preferably constituting between 85 to 90 percent by weight of the particle. The outer inert polymer may include at least one polymer constituting between 10 to 15 percent by weight. The particle may preferably have a diameter 108 of between 17 to 20 microns. It may be further preferred that the PCM 100 may be non-toxic, non-corrosive, and non-hydroscopic. Inert in this application means the material is preferably chemically inert to reactions likely to occur in the disk environment.

FIG. 6 shows the encapsulated PCM 100 of FIGS. 4 and 5 filling a gap between two metal plates 110 in the disk cover 18, preferably filling an air gap often found between the upper and the lower plates of the disk cover. These plates are preferably made of a stainless steel underneath a polyurethane gasket cover. The encapsulated PCM preferably fills in gaps in disk base 16 of the disk drive 10 that may be created by machining and/or molding and/or casting of aluminum or other metals that may be used to form the disk base.

The PCM 100 may be placed on the surface of the disk base 16 and/or the disk cover 18 of the disk drive 10 as shown and discussed as a PCM coating 120 in FIGS. 7 and 8. The PCM coating may be a coating material that can be applied to other materials to help maintain the internal temperature of the disk drive 10 during normal operation regardless of surrounding environmental temperatures the disk drive may be exposed to. FIG. 7 shows a PCM coating applied to a metal plate 110 in a disk cover. FIG. 8 shows the PCM coating applied to a metal plate that may form part or all of the side or bottom of the disk base. PCM material added as a coating is preferably in the form of a composition including a PCM component and a component that provides mechanical stability for the PCM, particularly when the PCM is in liquid phase.

In addition, electronic circuitry of the disk drive 10 such as integrated circuits 42 and pin connectors 46 shown on the assembled circuit board 40 of FIG. 3 are often sensitive to overheating. Overheating can degrade the lifetime and/or the reliability of such parts. FIG. 9 shows at least one of the integrated circuits 42 and/or at least one of the connectors 46 covered with the PCM coating 120 and/or a PCM film 130.

FIG. 10 shows at least one of the integrated circuit 42 and/or at least one of the connectors 46 coupled through a PCM film 130 to the circuit board 48. For these devices, the PCM 100 may be implemented as a phase change thermal interface material or film preferably including a polymer/carrier filled with a thermally conductive filler. These materials preferably conform well to irregular surfaces and have wetting properties similar to thermal greases, which significantly reduce the contact resistance at the different interfaces. Due to this composite structure, phase change materials are able to withstand mechanical forces during shock and vibration, protecting the die and/or component from mechanical damage. The sinking of heat peaks using these implementations of the PCM are very reliable requiring no motors, electrical power, temperature measurements, or software.

The preceding embodiments provide examples of the invention, and are not meant to constrain the scope of the following claims.

What is claimed is:

1. A disk drive, comprising: a Phase Change Material (PCM) with a target temperature, whereby
said PCM releases heat in response to an ambient temperature outside said disk drive declining below said target temperature, and
said PCM absorbs heat in response to said ambient temperature rising above said target temperature.

2. The disk drive of claim 1, wherein said disk drive is a member of the group consisting of a ferromagnetic disk drive, a ferroelectric disk drive, a hybrid hard disk drive, a Redundant Array of Inexpensive Disks (RAID), and a solid state drive.

3. The disk drive of claim 1, wherein said PCM includes at least one component with a heat of fusion near said target temperature.

4. The disk drive of claim 3, wherein said PCM includes said component encapsulated in an inert outer shell.

5. The disk drive of claim 1, further comprising a disk base including said PCM.

6. The disk drive of claim 1, further comprising a disk cover including said PCM.

7. The disk drive of claim 1, further comprising an assembled circuit board mounted on said disk base, said assembled circuit board including said PCM thermally coupled to a heat sensitive component, whereby
said PCM thermally coupled to said heat sensitive component releases heat in response to said ambient temperature declining below said target temperature, and
said PCM thermally coupled to said heat sensitive component absorbs heat in response to said ambient temperature rising above said target temperature.

8. The disk drive of claim 7, wherein said heat sensitive component includes at least one instance of an integrated circuit.

9. The disk drive of claim 7, wherein said heat sensitive component includes at least one connector.

10. A disk base for said disk drive of claim 1, comprising: said PCM with said target temperature, whereby
said PCM releases heat in response to an ambient temperature declining below said target temperature, and
said PCM absorbs heat in response to said ambient temperature rising above said target temperature.

11. A disk cover for said disk drive of claim 1, comprising said PCM with said target temperature, whereby
said PCM in said disk cover releases heat in response to an ambient temperature declining below said target temperature, and
said PCM in said disk cover absorbs heat in response to said ambient temperature rising above said target temperature.

12. A method, comprising the step of:
operating a disk drive including a Phase Change Material (PCM) with a target temperature, further comprising the steps of:
releasing heat by said PCM in response to said ambient temperature declining below said target temperature; and
absorbing said heat by said PCM in response to said ambient temperature rising above said target temperature.

13. A method of making a disk drive, comprising the steps of: assembling at least one component including a Phase Change Material (PCM) with a target temperature to create said disk drive.

14. The method of claim 17, wherein said component is at least one member of the group consisting of: a disk base, a disk cover and an assembled circuit board.

15. The method of claim 14, further comprising the step of: manufacturing said disk base, further comprising at least one of the steps of:
forming said disk base including said PCM; and
coating said disk based with said PCM to create said disk base including said PCM.

16. The method of claim 14, further comprising the step of: manufacturing said disk cover, further comprising at least one of the steps of:
forming said disk cover including said PCM; and
coating said disk cover with said PCM to create said disk cover including said PCM.

17. An assembled circuit board, comprising a Phase Change Material (PCM) with a target temperature, whereby
said PCM releases heat in response to an ambient temperature declining below said target temperature, and
said PCM absorbs heat in response to said ambient temperature rising above said target temperature.

18. The assembled circuit board of claim 17, further comprising at least one heat sensitive component thermally coupled to said PCM.

19. The assembled circuit board of claim 18, wherein said heat sensitive component is an instance of at least one member of the group consisting of an integrated circuit and a connector.

20. A method, comprising the step of:
operating an assembled circuit board with an ambient temperature outside said assembled circuit board, said assembled circuit board including a Phase Change Material (PCM) with a target temperature, further comprising the steps of:
releasing heat by said PCM in response to said ambient temperature declining below said target temperature; and
absorbing said heat by said PCM in response to said ambient temperature rising above said target temperature.

21. The method of claim 20, wherein the step operating said assembled circuit board further comprises the step of operating at least one heat sensitive component thermally coupled to said PCM.

22. A method, comprising the step of assembling a circuit board with at least one Phase Change Material (PCM) with a target temperature to create an assembled circuit board including said PCM with said target temperature.

23. The method of claim 22, wherein the step assembling said circuit board further comprises the step of assembling at least one heat sensitive component with said circuit board and with said PCM to further create said assembled circuit board with said heat sensitive component thermally coupled to said PCM.
